(19) United States
(12) Patent Application Publication
(10) Pub. No.: US 2014/0294382 A1
(43) Pub. Date: Oct. 2, 2014

(54) COMMUNICATION APPARATUS AND COMMUNICATION METHOD USING THE SAME

(71) Applicant: ELECTRONICS AND TELECOMMUNICATIONS RESEARCH INSTITUTE, Daejeon (KR)

(72) Inventor: Seok-Jin LEE, Daegu (KR)

(73) Assignee: ELECTRONICS AND TELECOMMUNICATIONS RESEARCH INSTITUTE, Daejeon (KR)

(21) Appl. No.: 14/098,752

(22) Filed: Dec. 6, 2013

(30) Foreign Application Priority Data
Mar. 27, 2013 (KR) 10-2013-0033047

(51) Int. Cl. H04W 40/16; H04B 10/11; H04W 60/00; H04W 88/06

(52) U.S. Cl. CPC H04W 40/16; H04W 88/06; H04B 10/11; H04W 60/00
USPC 398/43; 370/338

(57) ABSTRACT

A communication apparatus includes a first communication unit configured to transmit and receive data using wireless LAN communication and a second communication unit configured to receive data using wireless communication that is different from the wireless LAN communication. The communication apparatus provides data, received through the first communication unit and the second communication unit, to a user terminal connected to a USB communication apparatus.

### CROSS-REFERENCE TO RELATED APPLICATION

This application claims priority to and the benefit of Korean Patent Application No. 10-2013-0033047 filed in the Korean Intellectual Property Office on Mar. 27, 2013, the entire contents of which are incorporated herein by reference.

### BACKGROUND OF THE INVENTION

(a) Field of the Invention

The present invention relates to a communication apparatus and a communication method using the same. More particularly, the present invention relates to a universal serial bus (USB) communication apparatus capable of enhancing wireless communication service speed using an asymmetrical parallel path.

(b) Description of the Related Art

A current universal serial bus (USB) commercial product chiefly includes a USB memory or a wireless LAN dongle.

In the case of a wireless LAN, a wireless environment can be deteriorated due to many users nearby or a collision between wireless signals due to various RF services using Industrial Scientific and Medical (ISM) bands. As a result, wireless communication service speed is confronted with an obstacle. In particular, in the case of high-capacity download data, communication quality is deteriorated due to a collision between wireless signals.

### SUMMARY OF THE INVENTION

The present invention has been made in an effort to provide a communication apparatus and a communication method using the same having the advantage of enhanced wireless communication service speed.

An exemplary embodiment of the present invention provides a communication apparatus connected to a user terminal. The communication apparatus includes a first communication unit, a second communication unit, and a communication control unit. The first communication unit transmits and receives data using wireless LAN communication. The second communication unit receives data using different wireless communication from the wireless LAN communication. Furthermore, the communication control unit transfers transmission data to the first communication unit and provide the user terminal with the data received through the first communication unit and the second communication unit.

The different wireless communication includes optical wireless communication.

The communication apparatus may further include a lens configured to receive data transferred in a light form and transfer the data to the second communication unit.

The different wireless communication may include at least one of visible light communication and infrared ray communication.

The communication apparatus may further include a first memory unit and a second memory unit. The first memory unit stores data read, written, and erased by the user terminal. Furthermore, the second memory unit stores fixed data.

The fixed data may include at least one of advertisement data, user authentication data, and a driver installation file and guide file for an operating system of the user terminal.

The communication apparatus may further include a memory control unit configured to process the access of the user terminal to the first memory unit and the second memory unit.

In accordance with another exemplary embodiment of the present invention, a communication apparatus connected to a user terminal is provided. The communication apparatus includes a first communication unit, a second communication unit, a first memory unit, and a second memory unit. The first communication forms a bidirectional wireless LAN communication path. The second communication unit forms a unidirectional reception path that is different from the wireless LAN communication path. The first memory unit stores data read, written, and erased by the user terminal. Furthermore, the second memory unit stores fixed data.

The communication apparatus may further include a communication control unit configured to register the wireless LAN communication path and the reception path with a routing control station.

The reception path may be formed through at least one of visible light communication and infrared ray communication.

In accordance with yet another embodiment of the present invention, a communication method of a communication apparatus is provided. The communication method includes registering a bidirectional wireless LAN communication path and a unidirectional reception path that is different from the wireless LAN communication path with a routing control station, receiving data from the routing control station through the wireless LAN communication path and the reception path, and sending the received data to a user terminal connected to the communication apparatus.

The reception path may be formed through at least one of visible light communication and infrared ray communication.

Registering a bidirectional wireless LAN communication path and a unidirectional reception path that are different from the wireless LAN communication path with a routing control station may include registering information on the wireless LAN communication path with the routing control station and registering the reception path with the routing control station along the wireless LAN communication path.

The communication method may further include sending data from the user terminal along the wireless LAN communication path.

The communication method may further include processing an access request for a memory unit of the communication apparatus in response to the access request received from the user terminal. Here, the memory unit may include a first memory unit for storing data read, written, and erased by the user terminal and a second memory unit for storing fixed data.

### BRIEF DESCRIPTION OF THE DRAWINGS

FIG. 1 is a diagram showing a USB communication apparatus in accordance with an exemplary embodiment of the present invention;

FIG. 2 is a diagram showing an example of an external appearance of the USB communication apparatus in accordance with an exemplary embodiment of the present invention;

FIG. 3 is a flowchart illustrating the transmission/reception operation of the USB communication apparatus in accordance with an exemplary embodiment of the present invention;

FIG. 4 is a flowchart illustrating a method of registering the communication path of a second communication unit corresponding to a detour reception path in accordance with an exemplary embodiment of the present invention; and

FIG. 5 is a flowchart illustrating the memory read and write operation of the USB communication apparatus in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

A communication apparatus and a communication method using the same in accordance with exemplary embodiments of the present invention are described in detail below with reference to the accompanying drawings.

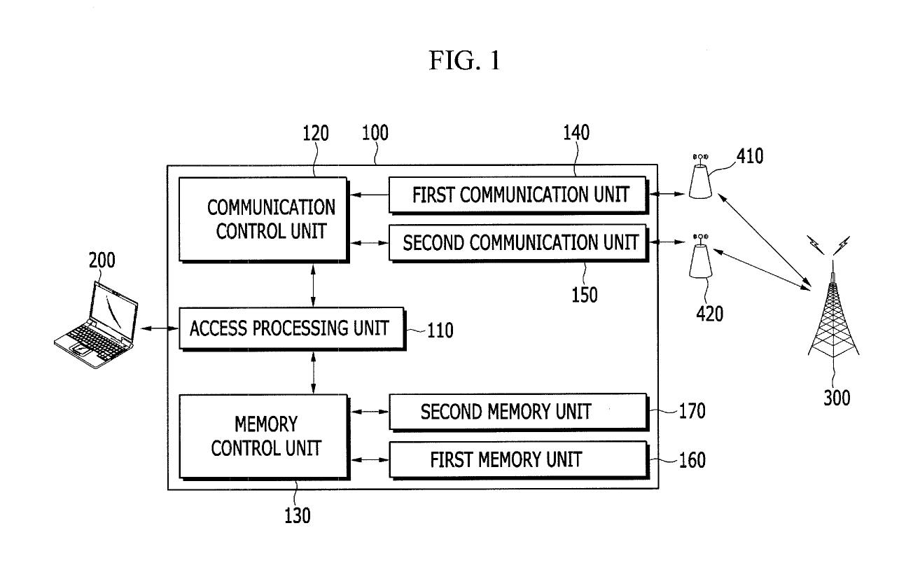

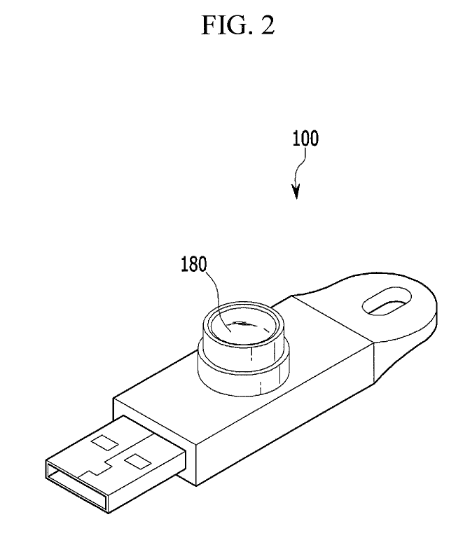

FIG. 1 is a diagram showing a USB communication apparatus in accordance with an exemplary embodiment of the present invention, and FIG. 2 is a diagram showing an example of an external appearance of the USB communication apparatus in accordance with an exemplary embodiment of the present invention.

Referring to FIG. 1, the USB communication apparatus 100 includes an access processing unit 110, a communication control unit 120, a memory control unit 130, a first communication unit 140, a second communication unit 150, a first memory unit 160, and a second memory unit 170.

The access processing unit 110 determines an access state with a user terminal 200, and analyzes and processes a request from the user terminal 200 accessed thereto. For example, if a request from the user terminal 200 is a reception request such as data download, or a transmission request such as data transmission, the access processing unit 110 transfers the request to the communication control unit 120. If a request from the user terminal 200 is a memory read and write request, the access processing unit 110 transfers the request to the memory control unit 130.

The communication control unit 120 sends the request of the user terminal 200 to a routing control station 300 through the first communication unit 140, receives a corresponding response through the first communication unit 140 and/or the second communication unit 150 from the routing control station 300, and provides the corresponding response to the user terminal 200.

The communication control unit 120 registers a wireless LAN communication path between the first communication unit 140 and a wireless LAN access point (AP) 410 and a reception path between the second communication unit 150 and an optical wireless AP 420 with the routing control station 300, thereby activating the communication paths of the first communication unit 140 and the second communication unit 150.

The first communication unit 140 and the second communication unit 150 perform communication using different communication methods.

The first communication unit 140 supports bidirectional communication between the user terminal 200 and the wireless LAN AP 410 and performs communication along a wireless LAN communication path using a wireless LAN method employing a radio frequency (RF). The first communication unit 140 includes an RF antenna, and includes a link layer including the physical (PHY) layer and medium access control (MAC) layer of a wireless LAN according to the IEEE 802.11 communication standard.

Unlike the first communication unit 140, the second communication unit 150 supports unidirectional communication from the optical wireless AP 420 to the user terminal 200, and performs communication along the reception path using a different communication method from the wireless LAN method employing an RF, for example, an optical wireless communication method. That is, the second communication unit 150 is only able to receive data from the optical wireless AP 420, but is unable to send data to the optical wireless AP 420. A visible light communication method or an infrared ray (IR) communication method may be used as the optical wireless communication method. The second communication unit 150 using the optical wireless communication method receives light through a photodiode, that is, a light-receiving semiconductor, converts the light into an electrical signal, and recovers received data from information that is included in the light by changing the reception intensity of the light through noise removal and amplification.

A common USB device only supports wireless LAN communication. In contrast, the USB communication apparatus 100 in accordance with an exemplary embodiment of the present invention supports both wireless LAN communication and optical wireless communication. Wireless LAN communication supports bidirectional communication, whereas optical wireless communication supports unidirectional communication. Accordingly, the USB communication apparatus 100 forms an asymmetrical parallel path. The user terminal 200 has more download data than upload data. Accordingly, if communication paths using different communication methods are secured using the USB communication apparatus 100 that forms an asymmetrical parallel path, corresponding download data can be provided to the user terminal 100 at a high speed.

The first memory unit 160 is a flash memory, and the user terminal 200 can perform read, write, and erase operations on the first memory unit 160.

The second memory unit 170 is the fixed memory region of the USB communication apparatus, and is used by the manufacturer of the USB communication apparatus 100 or the provider of the USB communication apparatus 100 for public information or advertisement purposes. The second memory unit 170 can store fixed data, such as advertisement data, public event information data, user authentication data, and a driver installation file and guide file for an operating system (OS).

The memory control unit 130 accesses the first memory unit 160 or the second memory unit 170 in response to a memory read and write request from the user terminal 200, and processes the memory read and write request.

The user terminal 100 can include a personal computer (PC) or a mobile phone.

The wireless LAN AP 410 and the optical wireless AP 420 communicate with the USB communication apparatus 100 and the routing control station 300 between the USB communication apparatus 100 and the routing control station 300.

The routing control station 300 communicates with the USB communication apparatus 100 to which the user terminal 200 is connected through the wireless LAN AP 410 and the optical wireless AP 420. If a reception request is received from the user terminal 200, the routing control station 300 properly distributes corresponding data and transfers the distributed data to the wireless LAN AP 410 and the optical wireless AP 420.

The wireless LAN AP 410 and the optical wireless AP 420 convert data received from the routing control station 300 so that they can send the converted data according by corresponding wireless communication methods and send the converted data to the first communication unit 140 and the second communication unit 150. For example, the optical wireless AP 420 can convert data, received from the routing control station 300, into light and send the light.

The USB communication apparatus 100 configured as described above can have an external appearance such as that shown in FIG. 2, and the USB communication apparatus 100 can be attachable to or detachable from the user terminal 200. That is, the USB communication apparatus 100 has a similar external appearance to a common USB device.

As shown in FIG. 2, the USB communication apparatus 100 may further include a lens 180 for receiving data corresponding to light from the optical wireless AP 420.

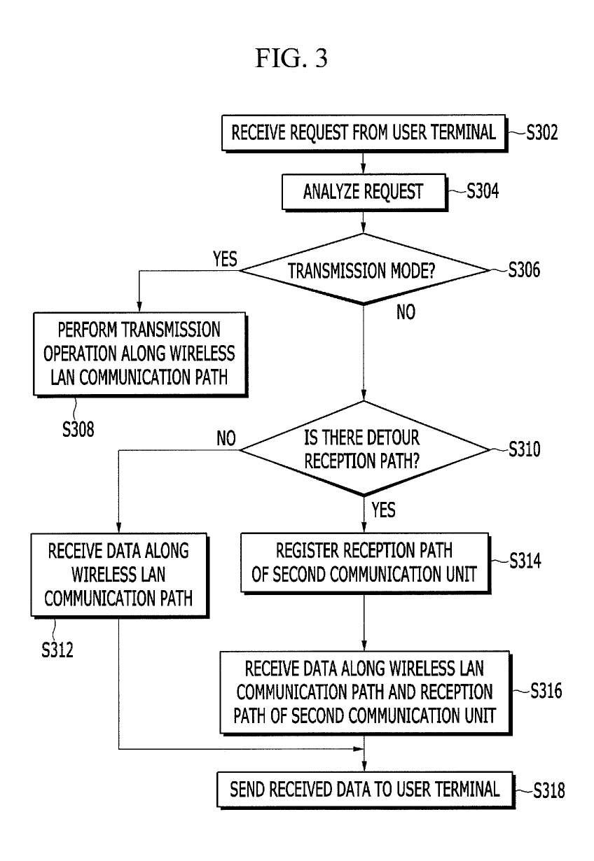

FIG. 3 is a flowchart illustrating the transmission/reception operation of the USB communication apparatus in accordance with an exemplary embodiment of the present invention.

Referring to FIG. 3, the access processing unit 110 of the USB communication apparatus 100 receives a request from the user terminal 200 accessed thereto at step S302, and analyzes the received request at step S304.

The access processing unit 110 determines an operating mode of the USB communication apparatus 100 depending on the received request at step S306. If the request of the user terminal 200 is a reception request such as data download, or a transmission request such as data transmission, the access processing unit 110 can determine the operating mode of the USB communication apparatus 100 as the transmission mode.

If the operating mode of the USB communication apparatus 100 is determined to be the transmission mode at step S306, a transmission operation is performed along the wireless LAN communication path of the first communication unit 140 at step S308.

If the request of the user terminal 200 is a reception request such as data download, the USB communication apparatus 100 sends the reception request in transmission mode and the operating mode of the USB communication apparatus 100 is then switched to reception mode.

If the operating mode of the USB communication apparatus 100 is determined to be the reception mode at step S306, the communication control unit 120 checks whether or not a detour reception path such as the reception path of the second communication unit 150 is present in addition to the wireless LAN communication path of the first communication unit 140 at step S310.

If, as a result of the check, a detour reception path is not present in addition to the wireless LAN communication path of the first communication unit 140, data is received along the wireless LAN communication path of the first communication unit 140 at step S312.

Meanwhile, if a detour reception path such as the reception path of the second communication unit 150 is present, in addition to the wireless LAN communication path of the first communication unit 140, the communication control unit 120 registers the reception path of the second communication unit 150 with the routing control station 300 through the first communication unit 140 in order to activate the reception path of the second communication unit 150 at step S314.

The routing control station 300 can distribute high-capacity data and send the distributed data to the wireless LAN AP 410 and the optical wireless AP 420. Accordingly, the distributed data is received along the wireless LAN communication path of the first communication unit 140 and the reception path of the second communication unit 150 at step S316.

The communication control unit 120 processes the data received along the wireless LAN communication path of the first communication unit 140 and/or the reception path of the second communication unit 150 and sends the processed data to the user terminal 200 at step S318.

As described above, the USB communication apparatus 100 in accordance with an exemplary embodiment of the present invention secures the dual data reception paths. Accordingly, the routing control station 300 can properly distribute high-capacity data and send the distributed data, and the data transmitted by the routing control station 300 can be received along the wireless LAN communication path of the first communication unit 140 and the detour reception path. As a result, the USB communication apparatus 100 can provide corresponding data to the user terminal 100 at higher speed than an existing USB device that depends on only wireless LAN communication. Furthermore, a data transmission load on wireless LAN communication can be reduced.

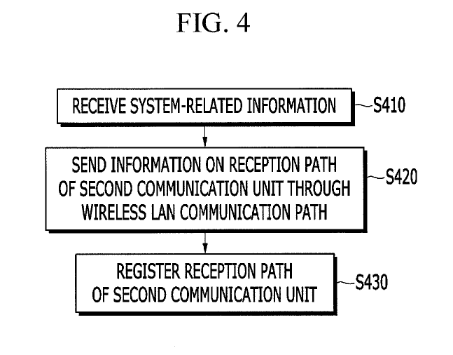

FIG. 4 is a flowchart illustrating a method of registering the communication path of the second communication unit corresponding to a detour reception path in accordance with an exemplary embodiment of the present invention. It is assumed that a communication path between the first communication unit 140 and the wireless LAN AP 410 has already been registered with the routing control station 300.

Referring to FIG. 4, the optical wireless AP 420 broadcasts system-related information necessary to access the optical wireless AP 420 to user terminals including the USB communication apparatus 100.

When the broadcasted system-related information is received at step S410, the second communication unit 150 sends information on the reception path of the second communication unit 150 to the wireless LAN AP 410 along the wireless LAN communication path of the first communication unit 140 at step S420. Thus, the reception path of the second communication unit 150 is registered with the routing control station 300 at step S430.

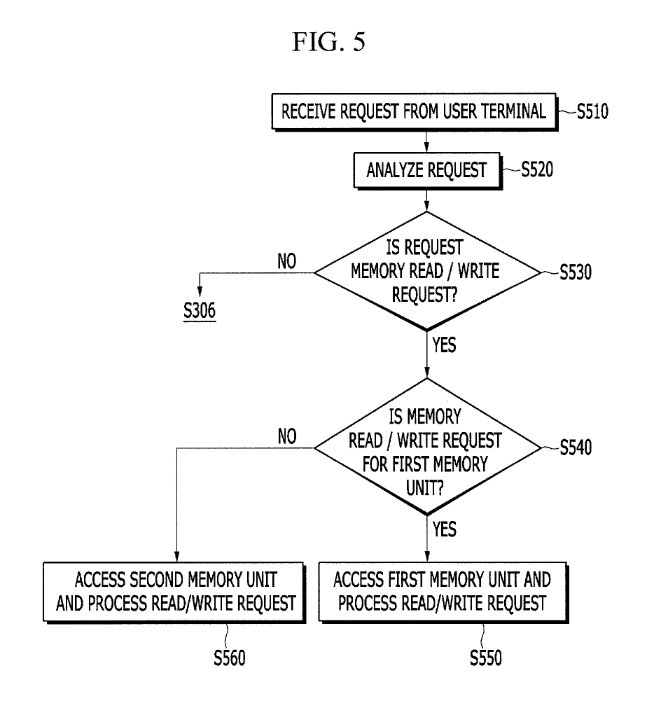

FIG. 5 is a flowchart illustrating the memory read and write operation of the USB communication apparatus in accordance with an exemplary embodiment of the present invention.

Referring to FIG. 5, the access processing unit 110 of the USB communication apparatus 100 receives a request from the user terminal 200 accessed thereto at step S510, and analyzes the received request at step S520.

If the received request is a memory read and write request at step S530, the access processing unit 110 transfers the request to the memory control unit 130.

The memory control unit 130 determines whether the request of the user terminal 200 is a read and write request for the first memory unit 160 or a read and write request for the second memory unit 170 at step S540.

If, as a result of the determination, it is determined that the request of the user terminal 200 is a read and write request for the first memory unit 160, the memory control unit 130 accesses the first memory unit 160 and processes the read and write request for the first memory unit 160 at step S550.

If, as a result of the determination, it is determined that the request of the user terminal 200 is a read and write request for the second memory unit 170, the memory control unit 130 accesses the second memory unit 170 and processes the read and write request for the second memory unit 170 at step S560.

The communication apparatus in accordance with exemplary embodiments of the present invention is not limited to the USB communication apparatus, for an example, may be applied to a communication apparatus using SD (Secure Digital) external memory card instead of the USB communication apparatus including the first and second memory units 160 and 170, and the first and second communication units 140 and 150.

In accordance with an exemplary embodiment of the present invention, wireless communication service speed can be enhanced by using a wireless LAN and heterogeneous wireless communication methods asynchronously and asymmetrically, and thus high-capacity data can be downloaded without deteriorating communication quality.

The exemplary embodiments of the present invention are not implemented by way of only the method and/or the apparatus, but may be implemented by way of a program for realizing a function corresponding to a construction according to an exemplary embodiment of the present invention or a recording medium on which the program is recorded. The implementations will be evident to a person having ordinary skill in the art to which the present invention pertains from the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication apparatus connected to a user terminal, comprising:
a first communication unit configured to transmit and receive data using wireless LAN communication;
a second communication unit configured to receive data using wireless communication different from the wireless LAN communication; and
a communication control unit configured to transfer transmission data to the first communication unit and provide the user terminal with the data received through the first communication unit and the second communication unit.

2. The communication apparatus of claim 1, wherein the different wireless communication comprises optical wireless communication.

3. The communication apparatus of claim 1, further comprising a lens configured to receive data transferred in a light form and transfer the data to the second communication unit.

4. The communication apparatus of claim 1, wherein the different wireless communication comprises at least one of visible light communication and infrared ray communication.

5. The communication apparatus of claim 1, further comprising:
a first memory unit configured to store data read, written, and erased by the user terminal; and
a second memory unit configured to store fixed data.

6. The communication apparatus of claim 5, wherein the fixed data comprises at least one of advertisement data, user authentication data, and a driver installation file and guide file for an operating system of the user terminal.

7. The communication apparatus of claim 5, further comprising a memory control unit configured to process access of the user terminal to the first memory unit and the second memory unit.

8. A communication apparatus connected to a user terminal, comprising:
a first communication unit configured to form a bidirectional wireless LAN communication path;
a second communication unit configured to form a unidirectional reception path different from the wireless LAN communication path;
a first memory unit configured to store data read, written, and erased by the user terminal; and
a second memory unit configured to store fixed data.

9. The communication apparatus of claim 8, further comprising a communication control unit configured to register the wireless LAN communication path and the reception path with a routing control station.

10. The communication apparatus of claim 9, wherein the communication control unit registers the reception path with the routing control station along the wireless LAN communication path.

11. The communication apparatus of claim 8, wherein the reception path is formed through at least one of visible light communication and infrared ray communication.

12. The communication apparatus of claim 8, wherein the fixed data comprises at least one of advertisement data, user authentication data, and a driver installation file and guide file for an operating system of the user terminal.

13. A communication method of a communication apparatus, comprising:
registering a bidirectional wireless LAN communication path and a unidirectional reception path that is different from the wireless LAN communication path with a routing control station;
receiving data from the routing control station through the wireless LAN communication path and the reception path; and
sending the received data to a user terminal connected to the communication apparatus.

14. The communication method of claim 13, wherein the reception path is formed through at least one of visible light communication and infrared ray communication.

15. The communication method of claim 13, wherein registering a bidirectional wireless LAN communication path and a unidirectional reception path that are different from the wireless LAN communication path with a routing control station comprises:
registering information on the wireless LAN communication path with the routing control station; and
registering the reception path with the routing control station along the wireless LAN communication path.

16. The communication method of claim 13, further comprising sending data from the user terminal along the wireless LAN communication path.

17. The communication method of claim 13, further comprising processing an access request for a memory unit of the communication apparatus in response to the access request received from the user terminal,
wherein the memory unit comprises:
a first memory unit for storing data read, written, and erased by the user terminal; and
a second memory unit for storing fixed data.

18. The communication method of claim 17, wherein the fixed data comprises at least one of advertisement data, user authentication data, and a driver installation file and guide file for an operating system of the user terminal.
